(19) United States
(12) Patent Application Publication
(10) Pub. No.: US 2016/0121574 A1
(43) Pub. Date: May 5, 2016

(54) FOLDING DEVICE, USE OF THE SAME AND A METHOD FOR PRODUCING AN INFORMATION PRESENTING DEVICE

(71) Applicant: MIZELDA AB, Ramlösa (SE)

(72) Inventor: Jani Mirsch, RAMLÖSA (SE)

(73) Assignee: Mizelda AB, RAMLÖSA (SE)

(21) Appl. No.: 14/896,374

(22) PCT Filed: Jun. 3, 2014
(86) PCT No.: PCT/SE2014/050674

§ 371 Date: Dec. 5, 2015

(30) Foreign Application Priority Data
Jun. 5, 2013 (SE) 1350688-6

(51) Int. Cl. B31F 1/00; B31D 5/04; B31B 5/26

(52) U.S. Cl. CPC B31F 1/0009; B31B 5/26; B31D 5/04; B31B 2203/00

(57) ABSTRACT

The present invention relates to a folding device (140) for folding of a blank for producing an information presenting device. The folding device (140) is arranged for receiving a blank (AB) with two opposite side edge portions (123a, 123b). The folding device (140) comprises two holding devices (141a, 141b) for holding the blank (AB) on each side of a folding line (VL). The holding devices (141a, 141b) is arranged for relative movement towards each other for folding the blank (AB) about the folding line (VL). The folding device (140) further comprises a compensation unit (142) which is arranged for displacement of the holding devices (141a, 141b) relative to each other during holding of the blank (AB). The compensation unit (142) is arranged for relative displacement of the holding devices (141a, 141b) such that the side edge portions (123a, 123b) are aligned relative to each other.

### TECHNICAL FIELD

The present invention relates to a folding device for folding of a blank for producing an information presenting device. The present invention also relates to the use of the folding device and a method for folding of a blank for producing an information presenting device.

### BACKGROUND

Presentation of information such as messages or sale advertising, so-called store advertising is today commonplace. A common way to present the information is by means of self-supporting advertising pillars formed of cardboard material. When producing advertising pillars a variety of manufacturing processes may be used. According to a commonly used method sheets of cardboard or corrugated board is/are manually folded and/or joined together for forming an advertising pillar. In connection with the folding and/or joining together it is common for a tension element to be applied in order to lock the advertising pillar in an extended display configuration.

Manual production of advertising pillars gives that it is possible to produce an advertising pillars of high quality with an attractive appearance. In other words, advertising pillars with an attractive appearance may only be made if the work is done with sufficient accuracy.

Manual production brings however, limitations in terms of production speed, which is a problem. As an advertising pillar is to be made manually with a desired quality numerous production steps needs to be made, which by nature is time consuming.

Given the above problem(s) it has been proposed to at least partially automate the production of advertising pillars for achieving an increased production speed.

However, by automating the production of advertising pillars problems with the quality of the manufactured advertising pillars may arise. The manufactured advertising pillars may e.g. exhibit a lower quality and a less attractive appearance.

Accordingly, there is a need for an improved at least partially automated process for producing of advertising pillars of a uniform high quality and attractive appearance.

### SUMMARY OF THE INVENTION

An object of the present invention is to provide a folding device for folding of a blank for producing an information presenting device.

According to a first aspect of the invention a folding device for folding of a blank for producing an information presenting device is provided. The information presenting device to be folded by means of the folding device comprises a first and an associated, opposite second panel, and the information presenting device is arranged to assume a first configuration, in which the device is flattened for transport or storage, and a relative to the first configuration, expanded second configuration. The folding device is arranged for receiving a blank with two opposite side edge portions. The folding device comprises two or more holding devices for holding the blank on each side of a folding line. The holding devices are arranged for relative movement towards each other for folding the blank about the folding line. The folding device further comprises a compensation unit which is arranged for displacement of the holding devices relative to each other during holding of the blank. The compensation unit is arranged for relative displacement of the holding devices such that the side edge portions are aligned relative to each other.

The present invention is based on the insight that the information presentation devices of high quality with appealing aesthetic properties can be made when a blank is folded by a folding device which can displace the side edge portions of the blank relative to each other. By displacing the holding devices of the folding device relative to each other, the side edge portions of the blank may be displaced relative to each other when held by the holding devices. It is thus possible, by means of the folding device, to align the side edge portions of the blank. By aligning the side edge portions of the blank an information presentation devices of high quality with appealing aesthetic properties can be made.

By “information presentation device” is meant any device comprising a first and an associated, opposite second panel. The device is further arranged to assume a first configuration, in which the device is flat, and an, in relation to the first configuration, expanded second configuration. The device may further be used to present information. An example of such a device is an expandable advertisement or advertising pillar. The information to be presented may be printed, painted, stamped or the like, on a surface of information presentation device. Likewise the information presentation device may be intended to be provided with information, for example in the form of a placard, a handbill, a poster, a self-adhesive sticker, writing, or similar.

By “folding line” is meant an imaginary line around which a blank may be folded or is folded. The folding line prior to folding may be purely imaginary and thus not visible or marked in any way. Alternatively, the folding line prior to folding may be visible or marked, for example by a visual marker or a mechanical instruction applied to the material to be folded. The folding line can thus, for example, be marked by a printed or painted line, or similar. Furthermore, the folding line may be marked by e.g. a perforation, an indication of fracture, an embossing or similar, in the blank. Thus, the folding line is defined by the zone in which the folding occurred when the blank is folded about the folding line.

By “blank” is meant any starting material used to form the opposing panels of an information presentation device. A blank may consist of one or several pieces. When several pieces are used for forming the blank they may be joined together for forming the blank. The blank used is in most cases in the form of a sheet, but may also be of another form. The blank may be made of cardboard, pasteboard, paperboard, corrugated cardboard, plastic or metal. Furthermore, the blank may comprise of a combination of several different materials.

The folding device may further comprise a joining device for joining together the side edge portions after completion of folding. By aligning the side edge portions before the joining of the same an information presentation device of high quality with appealing aesthetics may be achieved. The inventive folding device may thus counteract biases in the information presentation device by aligning the side edge portions before joining the side edge portions together.

According to a second aspect of the present invention a method for producing an information presenting device comprising a first and an associated, opposite second panel, wherein the information presenting device is arranged to assume a first configuration, in which the device is flattened for transport or storage, and a relative to the first configuration, expanded second configuration is provided. The method comprising providing a blank; holding, by means of a folding device comprising two holding devices, the blank on each side of a folding line, folding, by means of the folding device, the blank about the folding line such that two opposite side edge portions of the blank are brought together; before, during or after the folding of the blank, relative displacing the holding devices such that the side edge portions are aligned relative to each other; joining together the aligned side edge portions.

Since the side edge portions of the blank are aligned before they are joined the inventive method enables production of information presentation devices of high quality with appealing aesthetic characteristics. This second aspect of the invention achieves similar advantages as discussed above in connection with the first aspect of the invention.

The method may further comprise attaching a locking member at one of the side edge portions and at a section adjacent to the folding line.

The method may further comprise folding, before, during or after the folding of the blank, the opposite side edge portions. This is advantageous since the assembly of the side edge portions is facilitated.

According to a third aspect of the invention use of the folding device according to the first aspect for folding of a blank for producing an information presenting device is provided.

Additional applications, embodiments and advantages of the present invention are clarified in the detailed description below. It should be understood that the detailed description and the examples which illustrate preferred embodiments of the invention, are given as explanatory examples only. Various changes and modifications within the scope of the invention will be apparent to those skilled in the art.

### BRIEF DESCRIPTION OF THE DRAWINGS

Below, the invention will be described in example with reference to the accompanying drawings which illustrate currently preferred embodiments.

FIG. 1 and FIG. 2 are perspective views of a folding device for folding a blank for making an information presentation device.

FIG. 3 shows a schematic flow diagram of a method of the invention.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

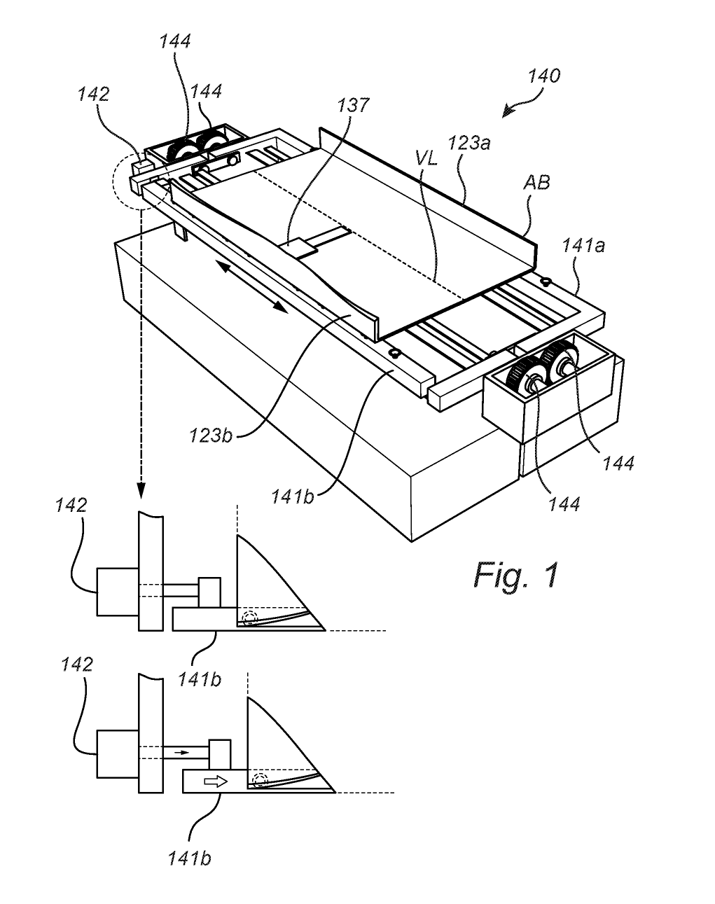

FIG. 1 displays a blank AB with an applied locking member 137 in a folding device 140. The locking member 137 is used to secure the information presentation device in its second configuration after the completion of the information presentation device. Further, the information presentation device may be locked in configurations in between the first and the second configuration. The person skilled in the art will appreciate that the locking member 137 may be formed in innumerable ways.

The folding device 140 shown in FIG. 1 is provided with holding devices 141a, 141b which are provided with suction cups. The holding device 141b is displaceable in its longitudinal direction so that it is displaceable relative to the holding device 141a. For this purpose, there is provided a compensating unit 142 which is so designed that it can displace the holding device 141b a desired distance in the longitudinal direction of the holding device 141b. The compensating device 142 may be configured to include a pneumatic piston that performs the actual movement of the holding device 141b. For, in a controlled way, controlling the movement of the holding device 141b the compensating unit 142 may be provided with an adjustable stop, not shown, towards which the pneumatic piston is pressing the holding device 141b. It is thus possible to adjust how much the holding means 141b may be adjusted by adjusting the stop.

In the folding device 140 the blank AB is held in place using the holding devices 141a, 141b. As the blank AB may be held adjacent to the side edge portions 123a, 123b also the side edge portions 123a, 123b may be displaced relative to each other as the holding devices 141a, 141b are displaced relative each other.

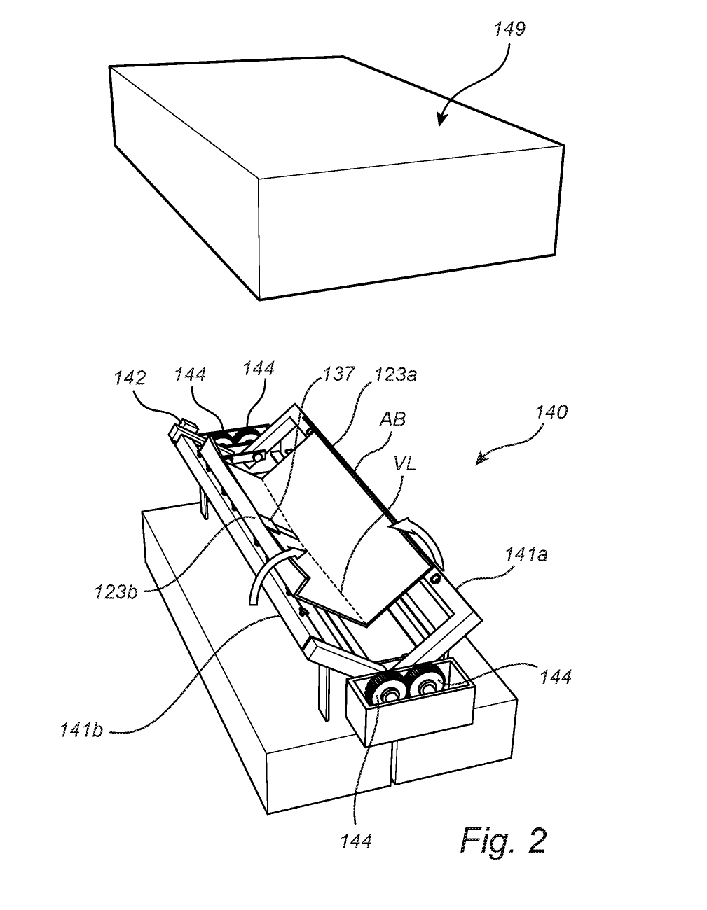

The folding device 140 is further so designed that it may be folded about its center by means of gears 144 as shown in FIG. 2. The folding device 140 may thus fold the blank AB when it is held in place so that the blank is folded about a center line. When the both halves of the folding device 140 are folded together will thus also the blank be folded and the two side edge portions 123a, 123b are moved towards each other. Hence, by doing so a folding of the blank AB about a folding line VL adjacent to a center line of the blank AB will occur.

If a locking member 137 has previously been applied to the blank AB internal stress in the blank AB may arise in connection with the folding about the folding line VL. This may result in that the two side edge portions 123a, 123b are not aligned with respect to each other after performing the folding about fold line VL. It is thus now possible, by means of the compensation unit 142 to displace the, in the holding device 141b fixed in place, side edge portion 123b so as to be aligned with the, in the holding device 141a fixed in place, side edge portion 123a. The displacement performed by the holding device 141b may be performed before, during or after the folding of the blank AB along the fold line VL.

After completed folding the side edge portions 123a, 123b may be joined together by means of a joining device 149. The joining device 149 may be arranged so that after completion of the folding of the blank AB it may hold the blank AB in place and join the side edge portions 123a, 123b. The retention may be done by suction cups, not shown, or other members suitable for the purpose of holding the blank AB. For performing the actual joining together the joining device 149 may be provided with a nozzle, not shown, from which hot melt adhesive may be applied to one of the side edge portions 123a, 123b, or to both side edge portions 123a, 123b. When the adhesive has been applied, the side edge portions 123a, 123b are pressed together by the joining device 149 while the adhesive is allowed to cure. The pressing together may e.g. be made by means of bringing the members or suction cups holding the blank AB together by joining device 149 so that the side edge portions 123a, 123b are pressed together. When the adhesive has been cured the side edge portions 123a, 123b are joined to each other.

Further, the joining device 149 may be provided with means, not shown, being arranged for folding the side edge portions 123a, 123b of the blank AB. The means may thus facilitate the joining together of the side edge portions 123a, 123b by that they are folded so that the surfaces of the side edge portions 123a, 123b to be joined together are arranged opposite to each other.

The person skilled in the art will recognize that the above described folding device may be modified in numerous ways within the inventive concept.

Therefore variants of the folding device and its elements, etc. will be described below. This in order to provide example possible modifications of the folding device 140.

The holding devices 141a, 141b may for example be designed as claws which grip the blank, also elongated or intermittently arranged stops may be used to grip the blank AB.

Furthermore, the adhesive as described above may be replaced by other types of adhesives and fasteners, such as self-adhesive pads, adhesive tape, double sided tape, staples, cable ties, edge moldings, a stitch, wire, bolts or the like. It is thus possible to perform the above-described joining of the side edge portions 123a, 123b via any element or method in accordance with what has been stated above.

Further, the compensation unit 142 may be designed in a variety of ways. The compensating unit 142 may e.g. comprise a stepper motor, a pneumatic piston, a hydraulic piston, a screw motor, a threaded device or the like. It is also possible to provide the folding device 140 with a measuring device, not shown, which measures the displacement to be performed by the compensating unit 142. The measured displacement can then thus be sent to the compensation unit 142 that may compensate in accordance with the measurement. The compensating unit 142 may thus be manually adjustable, as well as automatically adjustable. The compensating unit 142 may also be designed so that it can make adjustments in a plurality of directions. In practice, it may be designed so that it can perform adjustments in all six available degrees of freedom of the holding device 141b. The compensating unit 142 may also be arranged so that it can adjust both the holding device 141b and the holding device 141a.

Also the gears 144 used to fold the folding device 140 may be designed in numerous ways. For example, hydraulic or pneumatic rams may instead be used to fold the folding device 140. Moreover, screw devices, stepping motors or other devices may also alternatively or in combination be used.

It is to be understood that the folding device 140 can be used for folding blanks provided with members other than the above-described locking member 137. For instance, the folding apparatus 140 may be used for folding blanks that have provided with strips, reinforcements or other elements. The folding device 140 may also be used for folding blanks which are not provided with additional elements.

Also, the locking member 137 may be attached with adhesive or other fasteners, such as self-adhesive mounting pads, adhesive tape, double sided tape, staples, cable ties, edge moldings, a stitch, wire, bolts or the like, similar to what is described above.

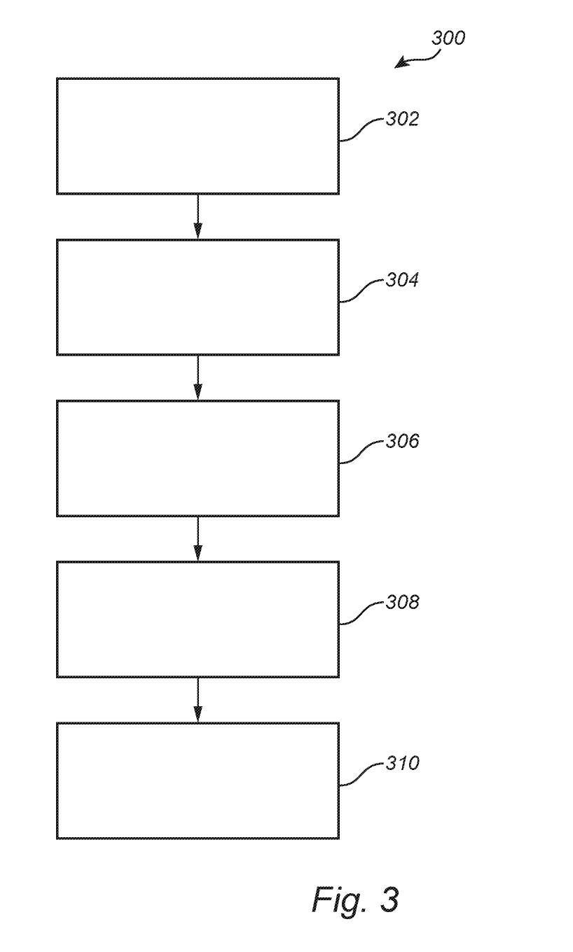

With reference to FIG. 3 a method 300 for producing an information presentation device will be described.

In a first step 302 of the method 300 a blank AB is provided. The blank AB will be transformed into information presenting device in accordance with what has been described above.

In a second step 304 of the method the blank AB is held in place by two holding devices 141a, 141b on each side of a folding line VL. This can be done in accordance with what has been described above.

In a third step 306 of the method 300 the blank is folded about the folding line VL by means of the holding devices 141a, 141b. This is done so that the two opposite side edge portions 123, 123b of the blank AB is brought together in accordance with what is described above.

In a fourth step 308 of method 300 the holding devices 141a, 141b are displaced relative each other so that the side edge portions 123a, 123b are aligned relative to each other. Relative displacement of the holding devices 141a, 141b may be performed before, during or after the folding of the blank AB in accordance with that described above.

In a fifth step 310 of method 300 the aligned side edge portions 123a, 123b are joined together in accordance with that described above.

The person skilled in the art realizes that the present invention by no means is limited to the preferred embodiments described above. On the contrary, many modifications and variations are possible within the scope of the appended claims. Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A folding device for folding of a blank for producing an information presenting device comprising a first and an associated, opposite second panel, wherein the information presenting device is arranged to assume a first configuration, in which the device is flattened for transport or storage, and a relative to the first configuration, expanded second configuration,
the folding device being configured to receive a blank with two opposite side edge portions, wherein the folding device comprises two holding devices for holding the blank on each side of a folding line, the holding devices are arranged for relative movement towards each other for folding the blank about the folding line, wherein the folding device further comprises:
a compensation unit configured to displace the holding devices relative to each other during holding of the blank,
wherein the compensation unit is arranged for relative displacement of the holding devices such that the side edge portions are aligned relative to each other.

2. The folding device according to claim 1, wherein the folding device further comprises a joining device configured to join together the side edge portions after completion of folding.

3. A method or producing an information presenting device comprising a first and an associated, opposite second panel, wherein the information presenting device is arranged to assume a first configuration, in which the device is flattened for transport or storage, and a relative to the first configuration, expanded second configuration, the method comprising:
providing a blank,
holding, using a folding device comprising two holding devices, the blank on each side of a folding line,
folding, using the folding device, the blank about the folding line such that two opposite side edge portions of the blank are brought together,
before, during or after the folding of the blank, relatively displacing the holding devices such that the side edge portions are aligned relative to each other,
joining together the aligned side edge portions.

4. The method according to claim 3, further comprising attaching a locking member at one of the side edge portions and at a section adjacent to the folding line.

5. The method according to claim 3, further comprising folding, before, during or after the folding of the blank, the opposite side edge portions.

6. The folding device of claim 1, wherein the folding of a blank results in producing an information presenting device.
